(19) United States
(12) Patent Application Publication
(10) Pub. No.: US 2025/0252449 A1
(43) Pub. Date: Aug. 7, 2025

(54) LIFESTYLE GROUP-BASED NORMATIVE MESSAGING FOR HOUSEHOLD ENERGY CONSUMPTION REDUCTION

(71) Applicant: THE REGENTS OF THE UNIVERSITY OF MICHIGAN, Ann Arbor, MI (US)

(72) Inventors: SangHyun Lee, Ann Arbor, MI (US); Kwonsik Song, Fishers, IN (US); Hoonyong Lee, Ann Arbor, MI (US); Kaitlin T. Raimi, Ann Arbor, MI (US); Philip Solomon Hart, Ann Arbor, MI (US); Jinwoo Kim, Incheon (KR)

(21) Appl. No.: 18/431,732

(22) Filed: Feb. 2, 2024

(51) Int. Cl. G06Q 30/018; G05B 15/02

(52) U.S. Cl. CPC G06Q 30/018; G05B 15/02; G05B 2219/2642

(57) ABSTRACT

Methods and systems are disclosed to automatically reclassify households into a plurality of behavioral reference groups based on changing household energy usage data, and dynamically recluster the households into new behavioral reference groups when conditions are met. Once the households have been classified to appropriate behavioral reference groups, personalized, normative, energy use feedback messages are generated for the households of each behavioral reference group. An effectiveness of the customized messages at reducing household energy consumption may be monitored, and the customized messages may be adjusted over time to maximize the reductions in household energy consumption.

### TECHNICAL FIELD

Embodiments of the subject matter disclosed herein relate to monitoring and analyzing household energy consumption, and in particular, to reducing energy consumption through effective messaging.

### BACKGROUND AND SUMMARY

Residential energy consumption is a significant contributor to the climate crisis as energy production has been the largest contributor to greenhouse gas emissions. In recent years, residential energy consumption has been rising due to factors such as population growth, urbanization, and the adoption of new technologies. As a result, reducing residential energy consumption has become an issue that has attracted global attention from countries, organizations, and individuals. Historically, efforts at household energy reduction have been directed towards subsidies, tax incentives, or investment in energy-efficient equipment for a specific population. These approaches, however, may be costly and difficult to scale up implementation to many householders. In addition, identifying and reaching the targeted population may entail applying significant resources, and there could be concerns that such an approach disproportionately benefits certain groups.

In an example, the present application identifies each household's approximate lifestyle using household energy consumption. As a result, the effectiveness of normative messaging can be maximized by taking advantage of the effects of group identification by individuals receiving the messaging.

Thus, within residences, normative messaging interventions can encourage households to engage in various environmentally conscious behaviors. In norm-based intervention campaigns, clustering households into personally relevant reference groups may increase norm adherence, thus improving an effectiveness of normative messaging interventions. Advanced energy grid infrastructure, such as smart meters and cloud computing, enables the creation of highly personalized behavioral reference groups in a non-invasive manner by classifying or clustering households into highly similar user groups based on usage patterns.

However, one problem is that households are typically clustered into fixed groups based on general energy consumption patterns. As changes in household behaviors occur over time, norm adherence may degrade, reducing the effectiveness of the normative messaging interventions. Performing a periodic reclassification of households may rely on costly and inefficient manual intervention by human experts.

In one example, the issues described above may be addressed by a method for an energy reduction messaging system, the method comprising collecting a first set of energy consumption data from a plurality of households at a first time; performing a first clustering analysis of the first set of energy consumption data to identify a first plurality of behavioral reference groups of households that share similar behavioral patterns with respect to household energy usage; training a first classification model to classify each household of the plurality of households to a behavioral reference group of the first plurality of behavioral reference groups, based on the first set of energy consumption data; collecting a second set of energy consumption data from the plurality of households at a second time, the second time after the first time; and in response to a first set of conditions being met, automatically reclassifying one or more households of the plurality of households into the first plurality of behavioral reference groups using the trained first classification model.

The above advantages and other advantages, and features of the present description will be readily apparent from the following Detailed Description when taken alone or in connection with the accompanying drawings. It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

Various aspects of this disclosure may be better understood upon reading the following detailed description and upon reference to the drawings in which:

FIG. 1 shows a block diagram of an exemplary energy reduction messaging system for reducing household energy use, in accordance with one or more embodiments of the present disclosure;

FIG. 2 shows a schematic data flow diagram illustrating how the exemplary energy reduction messaging system may be used to generate effective messaging regarding reducing household energy consumption, in accordance with one or more embodiments of the present disclosure;

FIG. 3 is a flowchart illustrating an exemplary method for generating energy usage feedback messages for various classifications of households, in accordance with one or more embodiments of the present disclosure;

FIG. 4 shows a graph of an exemplary daily energy usage profile of a household, in accordance with one or more embodiments of the present disclosure;

FIG. 5 shows exemplary daily energy usage profiles of various classifications of households, in accordance with one or more embodiments of the present disclosure;

FIG. 6 is a flowchart illustrating an exemplary method for determining whether to reclassify one or more households based on energy consumption data using one or more trained classification models, in accordance with one or more embodiments of the present disclosure; and

FIG. 7 is a flowchart illustrating an exemplary method for determining whether to recluster the plurality of households based on energy consumption data using one or more clustering algorithms, in accordance with one or more embodiments of the present disclosure.

The drawings illustrate specific aspects of the described systems and methods. Together with the following description, the drawings demonstrate and explain the structures, methods, and principles described herein. In the drawings, the size of components may be exaggerated or otherwise modified for clarity. Well-known structures, materials, or operations are not shown or described in detail to avoid obscuring aspects of the described components, systems and methods.

### DETAILED DESCRIPTION

Methods and systems are provided herein for reducing household energy consumption through effective normative messaging, where households are first clustered into lifestyle groups based on existing energy consumption data using machine learning algorithms, and effective messaging interventions including energy usage pattern analysis are then tailored to each lifestyle group. In particular, an effectiveness of the normative messaging may be increased by performing periodic reclusterings and reclassifications of the households (e.g., reassignments of the households to a new lifestyle group) in accordance with the methods and systems described herein.

In the United States, residential buildings account for a large portion of energy expenditure and carbon dioxide (CO2) emissions, making them a prime target for energy reduction strategies. As occupant behaviors substantially influence household energy expenditures, behavioral interventions attempting to promote more pro-environmental household behaviors have become widespread. One advantage of behavior interventions aimed at reducing household energy consumption, compared to technological methods (e.g., retrofitting), is that behavioral intervention methods are often cost efficient and applicable to most if not all of the residential population.

A wide variety of behavioral intervention methods have been designed and implemented to increase pro-environmental behaviors, including reducing home energy use. One prominent intervention method for reducing home energy use is behavioral feedback, which is inexpensive to implement and has repeatedly been found to be effective at inducing occupants to reduce their energy consumption. Energy use feedback informs residents of their energy consumption (e.g., individual feedback), may be presented in numerous different forms (e.g., power in watts, cost, etc.), and can include descriptive and/or injunctive normative feedback elements. Descriptive normative feedback compares a household's energy consumption to a reference group, providing the household with the social norm of the group for home energy consumption.

In one example, the reference groups may be lifestyle groups that are determined based on the energy consumption data, and no other data.

Injunctive normative feedback indicates a level of social approval or disapproval of the household's behavior. For example, in one embodiment, normative messages may be created based on weekly energy consumption of nearby households, and provided to households via a smartphone application. Psychologists hypothesize that when individuals are given normative information from more personally relevant reference groups, the persuasiveness of the message and norm adherence increases.

Normative feedback reference groups may be based on geographical proximity (e.g., street, city, and distance), housing characteristics (e.g., housing size and heating type), and/or other criteria. However, geographical proximity and housing characteristics may not be accurate predictors of energy use, as energy usage patterns in similarly sized houses in a given neighborhood may vary substantially. Recently, the increased deployment of advanced energy grid infrastructure (e.g., smart energy meters and cloud computing systems) has offered new opportunities to overcome some of these limitations. With advanced energy metering technology, it is possible to collect highly granular energy consumption data in a non-invasive manner without requiring active participation from residents. Highly granular and readily available consumption data can be used to construct home energy usage profiles for each household. The energy usage profiles inherently include information about how occupants behave in their home. These profiles, in conjunction with geographic information and basic housing/household information, offer new opportunities to generate more personally relevant behavioral reference groups based on lifestyles of household occupants (e.g., lifestyle groups refer to groups of households that share similar lifestyles and/or behavioral patterns specifically with respect to household energy usage) for use in normative feedback messaging campaigns. With the addition of advanced computation systems (e.g., cloud computing), interveners can store and process a large volume of energy use data, making it possible to develop and deploy scalable personalized normative messaging interventions.

In order to isolate behavioral patterns, clustering algorithms may be applied to categorize the energy usage profiles of households into meaningful lifestyle groups without any prior knowledge of the lifestyle groups. In some cases, before conducting a clustering analysis, the dimensionality of energy use data may be reduced to improve clustering performance. The most widely used data reduction techniques include changing a resolution of energy use data (e.g., time interval), and projecting the original data into a lower dimensional subspace (e.g., principal component analysis). Once representative behavioral pattern lifestyle groups have been identified from historical energy use data, classifiers may assign energy consumers into the identified groups using newly collected consumption data and housing characteristics. This classification approach has been applied in personalized energy service marketing and demand response programs.

While it has been demonstrated that households can be classified into meaningful lifestyle/behavioral reference groups at any given time, the performance of behavioral reference group classification over time remains unclear. It is important to understand how classification performs over time, as households can exhibit different behavioral patterns in different billing cycles. If behavioral reference groups are fixed, when there are changes in household behaviors over time, norm adherence would be expected to degrade, reducing the effectiveness of the normative messaging interventions. As a result, the household behavioral reference groups may be periodically reassessed and households may be reassigned.

However, reassessing and reassigning of the household behavioral reference groups may be complicated. The clustering process may be costly in terms of processing and memory resource use. As a result, it may be desirable to minimize an amount of times behavioral reference group reclassification is performed, both to lower costs and to increase scalability to a larger population. Also, frequent reclassification (e.g., reassignment) of households to reference behavioral groups may undermine residents' identification with those groups.

In particular, determining how often and when to perform the behavioral reference group reclassification to maximize the results of a normative messaging campaign while minimizing a number of times the reclassification is performed, for example, in a year, may be challenging, and may rely on periodic human intervention to determine the appropriateness of the identified groups (e.g., differences in behavioral patterns between groups).

To address this issue, the inventors herein propose a novel approach to automating the dynamic reassignment (e.g., reclassification) of households to behavioral reference groups of a scalable, energy reduction messaging system, and the dynamic reclustering of households based on changing household energy usage data. An effectiveness of the customized messages at reducing household energy consumption may be monitored, and the customized messages may be adjusted over time to maximize the reductions in household energy consumption. In this way, households may be sent personalized normative feedback messages (e.g., personalized for a given behavioral reference group) at different intervals, where the different intervals are determined by the energy reduction messaging system. The proposed energy reduction messaging system may enable the assignment of highly personalized behavioral reference groups and personalized normative feedback messages to households in a scalable and non-invasive manner.

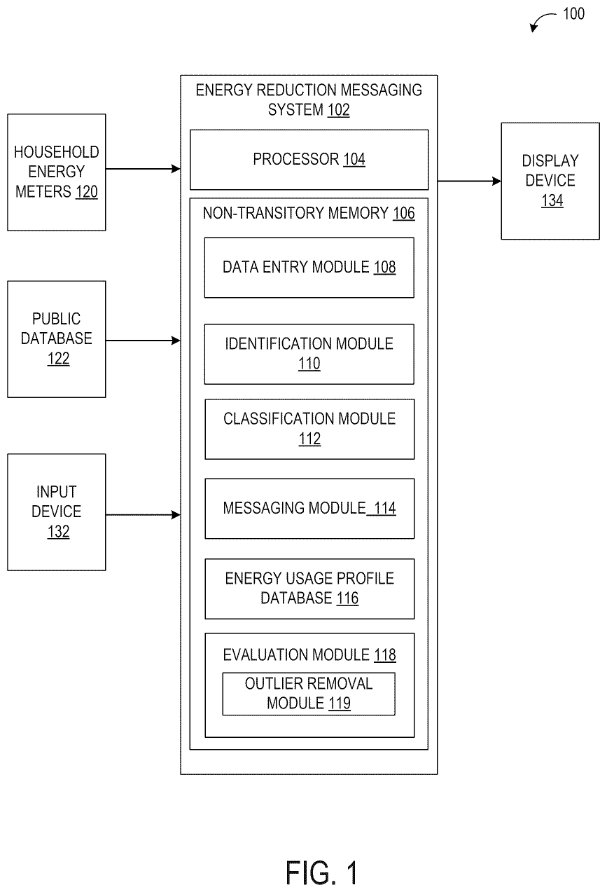

Referring to FIG. 1, an exemplary energy reduction messaging system 102 is shown, which may be used to dynamically classify households based on daily energy use patterns over various intervals. That is, energy reduction messaging system 102 may identify representative behavioral reference groups from historical energy use data, and dynamically reclassify households into the identified groups as new energy usage data is received.

Energy reduction messaging system 102 includes a processor 104 configured to execute machine readable instructions stored in non-transitory memory 106. In some embodiments, at least a portion of energy reduction messaging system 102 is disposed at a device (e.g., edge device, server, etc.) communicably coupled to other components of the energy reduction messaging system 102 via wired and/or wireless connections. Processor 104 may be single core or multi-core, and the programs executed thereon may be configured for parallel or distributed processing. In some embodiments, the processor 104 may optionally include individual components that are distributed throughout two or more devices, which may be remotely located and/or configured for coordinated processing. In some embodiments, one or more aspects of the processor 104 may be virtualized and executed by remotely-accessible networked computing devices configured in a cloud computing configuration.

Non-transitory memory 106 may store a data entry module 108, an identification module 110, a classification module 112, a messaging module 114, an energy usage profile database 116, and an evaluation module 118.

Data entry module 108 may include various components and/or technologies for receiving energy consumption data from a plurality of household energy meters 120. Each energy meter 120 may include one or more sensors to measure energy flow through the energy meter 120, and a built-in communication module (e.g., Wi-Fi, cellular, or RF technology) to transmit the measured energy data. The household energy meters 120 may collect daily energy consumption data at a respective plurality of households, using smart metering technology. The smart metering technology may measure energy consumption data in real-time or at predetermined intervals, often in increments of an hour or less. The measured energy consumption data may include an amount of energy consumed and may also record a time of energy consumption, allowing for time-stamped records. The time-stamping enables the measured energy consumption data to be segmented into different parts of the day (morning, afternoon, evening, night). Additionally or alternatively, the daily energy consumption data may be divided into hourly bins (e.g., a first energy consumption bin between 12:00 and 1:00, a second energy consumption bin between 1:00 and 2:00, etc.).

The measured energy consumption data may be transmitted periodically to Data Entry Module 108 via a network connection. When received, the measured energy consumption data may be validated to remove outliers or resolve inconsistencies. The data may then be categorized and stored in a structured format, such as representing it into six-hour intervals corresponding to morning (6 AM-12 PM), afternoon (12 PM-6 PM), evening (6 PM-12 AM) or night (12 AM-6 AM). Then, load shapes may be extracted from the daily energy usage profiles. One or more methods may be used for the load shape extraction (e.g., gradient, normalization, cumulative methods, etc).

Data entry module 108 may also receive housing characteristics from public records stored in one or more public databases 122. In one example, a size and/or footprint (in m²) of a house corresponding to a household may be extracted from a public database 122. The footprint may be a criterion used by a clustering model or classification model to associate the household with other households in a same lifestyle group (e.g., having similar energy consumption patterns). The housing characteristics may also include a user account and a daily energy consumption at predetermined intervals (e.g., 15 minutes). The housing characteristics may be used by the clustering or classification models to form a number of lifestyle groups. The number may be predetermined, or the number may depend on the housing characteristics. In one embodiment, households are divided into five groups based on the housing characteristics.

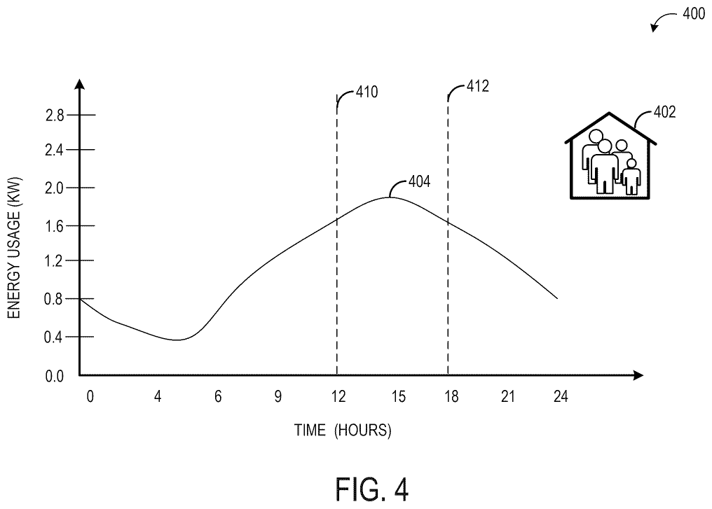

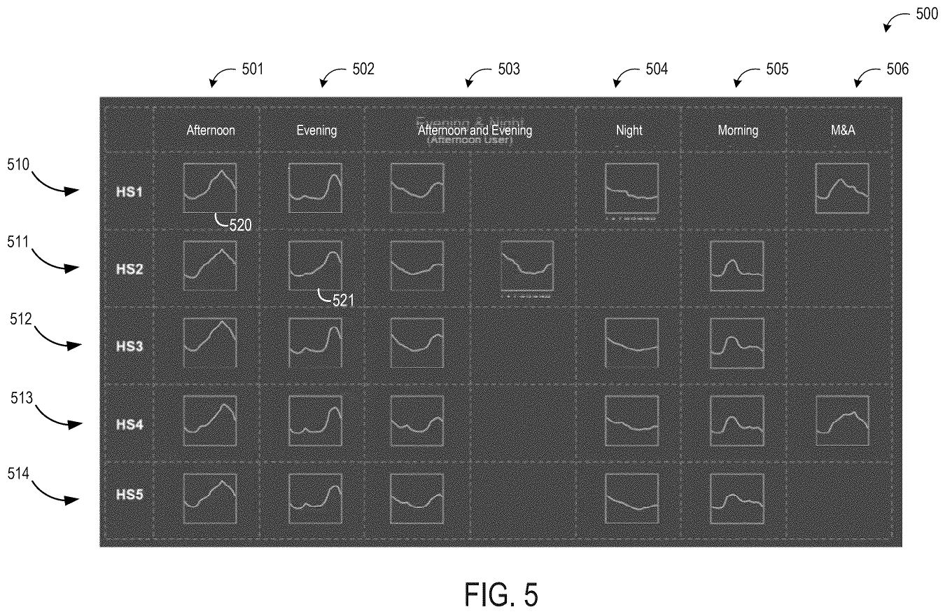

The daily energy consumption data and the housing characteristics data may be converted into daily energy usage profiles for each household, which may be stored in energy usage profile database 116. Each daily energy usage profile may indicate how energy is consumed by a given household over the course of a 24 hour period. The daily energy usage profiles are described in greater detail below in reference to FIGS. 4 and 5.

Identification module 110 may store instructions for performing one or more clustering analyses on historical energy consumption data collected from a plurality of households, to identify representative behavioral reference groups of households based on comparative energy consumption profiles. The clustering analyses may be performed based on data collected over one or more predefined time periods.

Classification module 112 may store instructions for training one or more classification models to classify households into one of the representative behavioral reference groups identified by identification module 110, based on historical household energy consumption profiles. The classification models may include statistical models, hierarchical models, machine learning (ML) models, such as support vector machine (SVM), decision tree (DT), or k-nearest neighbor (KNN) or deep learning (DL) models, such as autoencoder (AE), or a different type of model capable of performing a classification task. The models may be trained with labeled and/or unlabeled historical energy consumption data. In some embodiments, the energy consumption data may be time series data that is inputted into the models at regular intervals.

Classification module 112 may include one or more trained and/or untrained neural networks and may further include various data, or metadata pertaining to the one or more neural networks stored therein. Classification module 112 may also comprise instructions for training one or more of the neural networks implementing a deep learning model stored in classification module 112. In some embodiments, classification module 112 includes instructions for implementing one or more gradient descent algorithms, applying one or more loss functions, and/or training routines, for use in adjusting parameters of the one or more neural networks of classification module 112. Classification module 112 may also include instructions for classifying households into one of the representative behavioral reference groups based on a trained ML model.

Messaging module 114 may include instructions for generating personalized normative messages for households within each representative behavioral reference group. The personalized normative messages inform households with information about household energy consumption and the median consumption of their representative behavioral reference group as descriptive normative feedback and injunctive normative feedback that indicates how well they are doing with respect to saving energy.

Evaluation module 118 may store instructions for evaluating a performance of the energy reduction messaging system 102 at reducing energy consumption at participating households, based on the personalized normative messages sent to the different representative behavioral reference group. The system's performance may be statistically evaluated by comparing average energy consumption before and after an intervention (e.g., after providing the personalized normative messages). Additionally, a difference-in-difference (DiD) analysis may be used for the performance evaluation, which compares a change in energy consumption over time between control and treatment groups. The DiD analysis assumes that both the control and the treatment groups have the same trend of energy consumption over time in the absence of intervention. If the treatment group's energy consumption deviates from the control group, system effects may be considered.

The control group may include randomly selected households, whose electricity bills may indicate monthly energy usage without normative feedback. A number of households in the control group may be flexibly adjusted to ensure statistical significance of the performance evaluation. The performance of the systems may be evaluated depending on the behavioral reference group, energy load, housing characteristics, and a seasonal effect, as a significant portion of household energy is used for heating and cooling.

To accurately evaluate the performance of the system, households that exhibit unusual energy consumption patterns may be considered outliers and removed, for example, by an outlier removal module 119 of evaluation module 118. Households that use small amounts of energy may be eliminated because their energy usage may distort the true effects of the system on energy savings. In addition, households with significant annual fluctuations in energy usage may be removed because their residential behavior is different from other households that live in their homes regularly throughout the year.

Energy reduction messaging system 102 may be operably/communicatively coupled to a user input device 132 and a display device 134. User input device 132 may comprise one or more of a touchscreen, a keyboard, a mouse, a trackpad, a motion sensing camera, or other device configured to enable a user to interact with and manipulate data within energy reduction messaging system 102. Display device 134 may include one or more display devices utilizing virtually any type of technology. In some embodiments, display device 134 may comprise a computer monitor, and may display medical images. Display device 134 may be combined with processor 104, non-transitory memory 106, and/or user input device 132 in a shared enclosure, or may be peripheral display devices and may comprise a monitor, touchscreen, projector, or other display device known in the art, which may enable a user to view medical images produced by a medical imaging system, and/or interact with various data stored in non-transitory memory 106.

It should be understood that energy reduction messaging system 102 shown in FIG. 1 is for illustration, not for limitation. Another appropriate energy reduction messaging system may include more, fewer, or different components.

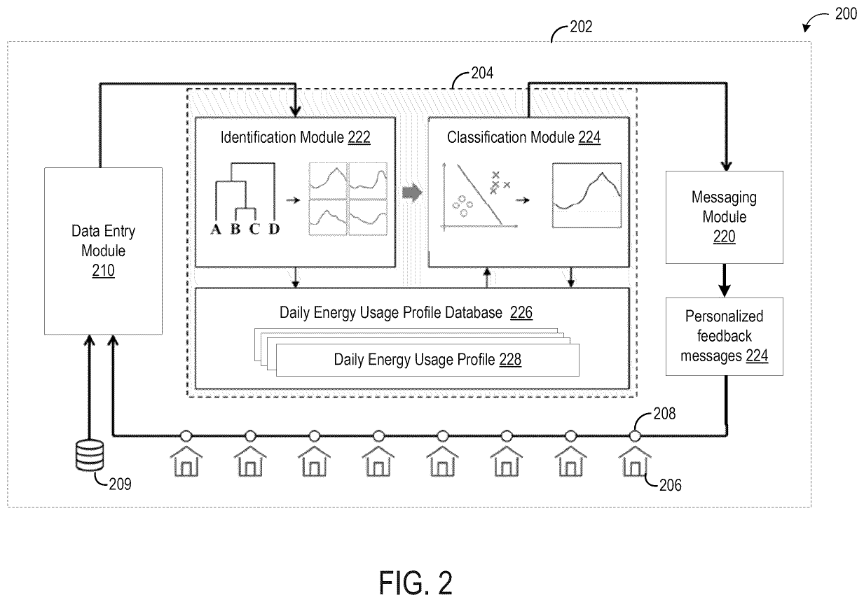

FIG. 2 shows a data flow diagram 200 that indicates a flow of data through a household energy monitoring ecosystem 202, where household energy monitoring ecosystem 202 includes an energy reduction messaging system 204, which may be a non-limiting example of energy reduction messaging system 102 described above in reference to FIG. 1. Household energy monitoring ecosystem 202 further includes a plurality of households 206. Each household 206 includes an energy meter 208, which may be a smart energy meter equipped with sensors to measure energy flow and a built-in communication module (e.g., Wi-Fi, cellular, or RF technology) to transmit data.

Each of the energy meters 208 may be communicatively coupled to a data entry module 210 (e.g., data entry module 108), where energy consumption data (such as daily energy consumption data) collected at each of the energy meters 208 may be transmitted to data entry module 210. Data entry module 210 may also retrieve information about each of the households 206 from one or more public databases 209. For example, the information may include a size of a house of the household; a number of individuals included in the households, including ages and/or other demographic data; a neighborhood or geographical location of the household; a size or footprint of a house of the household; and/or other data.

The energy consumption data may be transmitted from the data entry module 210 to an identification module 222 (e.g., identification module 110) of the energy reduction messaging system 204. At identification module 222, one or more clustering algorithms may be used to classify households into a plurality of representative behavioral reference groups, based on the energy consumption data collected at data entry module 210 over a predetermined period of time. For example, a clustering analysis may be performed based on data collected over a billing cycle, a season, or a year. Additionally, various clustering analyses may be performed over different time periods. For example, a first clustering analysis may be performed for a first season using a first model; a second clustering analysis may be performed for a second season using a first model; a third clustering analysis may be performed for a third season using a third model; and a fourth clustering analysis may be performed for a fourth season using a fourth model; where the first, second, third, and fourth models may be different models or different types of models. The models may include, for example, hierarchical clustering algorithms, k-means clustering algorithms, and/or different types of clustering algorithms.

Once the representative behavioral reference groups have been identified, a daily energy usage profile 228 may be generated for each household and associated with a respective representative behavioral reference group in a daily energy usage profile database 226.

The plurality of representative behavioral reference groups identified at identification module 222 may be transmitted to a classification module 224 (e.g., classification module 112). At classification module 224, one or more classification models may be trained to classify each household 206 into a closest matching representative behavioral reference group of the plurality of representative behavioral reference groups, based on the daily energy usage profile 228 of the household 206 stored in daily energy usage profile database 226. The one or more classification models may classify each household 206 in an ongoing manner, as energy usage patterns of the household 206 change. After the one or more classification models have been trained, the trained one or more classification models may be used to dynamically reclassify existing and new households 206 into the representative behavioral reference groups based on new energy consumption data measured at the meters 208 and collected at data entry module 210.

In other words, a household 206 may be periodically inputted into the trained one or more classification models, which may output a representative behavioral reference group that most closely matches the daily energy usage profile of the household 206. The household 206 may be classified into a first representative behavioral reference group by a clustering algorithm applied at identification module 222. However, the daily energy usage profile of the household 206 may change over time, for example, as household members reduce an amount of energy consumed during each day. As the daily energy usage profile changes, the household 206 may become more similar to households of a second representative behavioral reference group than the first representative behavioral reference group, whereby the trained one or more classification models may be used to reclassify household 206 into the second representative behavioral reference group.

As one example, a household 206 may be clustered into a first representative behavioral reference group at a first time, when the household 206 is not occupied during the day. At a second, later time, a resident of the household 206 may decide to work from home, whereby an energy consumption of the household may increase. The increase may be detected by energy reduction messaging system 204, and as a result of detecting the increase, energy reduction messaging system 204 may apply the one or more classification models to the household to reclassify the household 206. As result of the increase in energy consumption, the household 206 may be reclassified to a second representative behavioral reference group (e.g., a group characterized by a higher energy consumption).

A reclassification of a plurality of households to the behavioral reference groups may also be performed at various times, such as when seasons change, or in response to changes in temperature, or other factors, as described in greater detail below.

After the households 206 have been reclassified, the updated classifications of the households into appropriate representative behavioral reference groups are transmitted to a messaging module 220 (e.g., messaging module 114). At the messaging module 220, a personalized energy usage feedback message 224 is generated for the households 206 of each representative behavioral reference group. For example, a first personalized energy usage feedback message 224 may be generated for a first set of households 206 of a first representative behavioral reference group; a second personalized energy usage feedback message 224 may be generated for a second set of households 206 of a second representative behavioral reference group; and so on. The personalized energy usage feedback messages 224 may then be sent to each of the households 206.

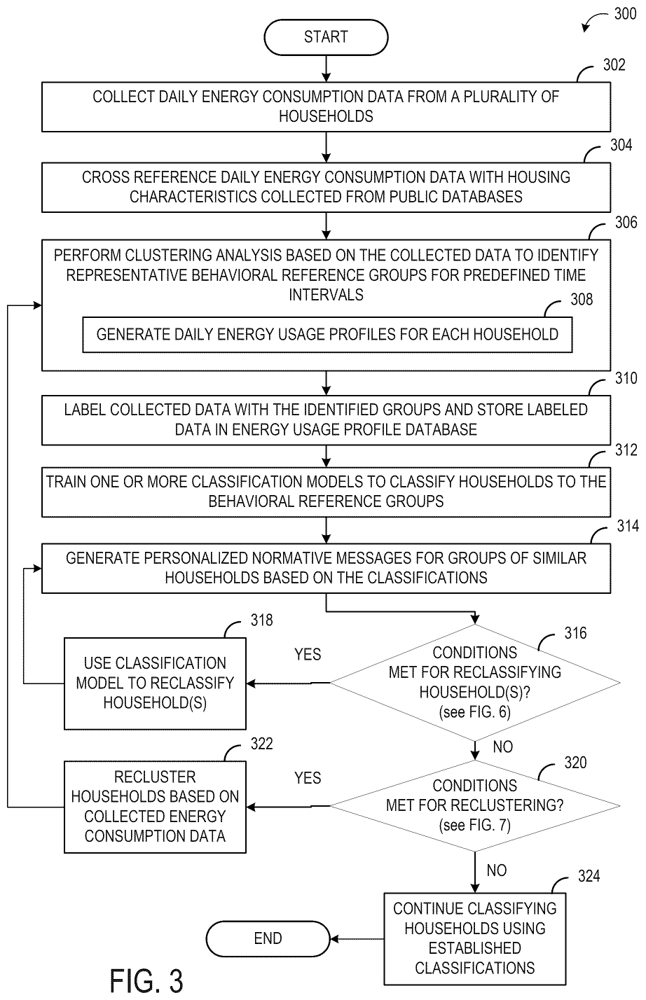

Referring now to FIG. 3, a flowchart is shown of a method 300 for generating personalized normative messages (e.g., energy usage feedback) for different classifications of households with respect to household energy consumption, based on representative behavioral reference groups generated using one or more clustering algorithms, and one or more trained classification models. Method 300 may be executed by a processor of an energy reduction messaging system, such as processor 104 of energy reduction messaging system 102 of FIG. 1. In an embodiment, some operations of method 300 may be stored in non-transitory memory of the energy reduction messaging system (e.g., non-transitory memory 106).

Method 300 begins at 302, where method 300 includes collecting daily energy consumption data from a plurality of households. The daily energy consumption data may be collected using smart metering technology, as described above.

At 304, method 300 includes cross-referencing daily energy consumption data with housing characteristics collected from public databases. For example, one housing characteristic may be a size of a house, since housing size may be a significant determinant of household energy use. In one embodiment, the households may be divided into groups based on a footprint (e.g., a surface area in m²) of a house, which may be extracted from public records of a public database (e.g., public database 122 of FIG. 1 and/or public database 209 of FIG. 2). For example, a first size grouping of households may include houses that are less than a first threshold surface area; a second size grouping of households may include houses with a surface area greater than the first threshold surface area and less than a second threshold surface area; third size grouping of households may include houses with a surface area greater than the second threshold surface area and less than a third threshold surface area; and so on. In other embodiments, additional and/or different housing characteristics may be used. While in one example the real-time household data that is utilized is energy consumption data, in some examples, additional data may be utilized based on the particular household, including square footage, lot size, number of bathrooms, and the type of construction materials of the house.

At 306, method 300 includes performing a clustering analysis based on the collected data to identify a plurality of representative behavioral reference groups for predefined time intervals. The clustering analysis may be performed using historical energy usage data collected from households over a period of time, such as a year, and the housing characteristics.

At 308, performing the clustering analysis may include generating daily energy usage profiles for each household of the plurality of households. The daily energy usage profiles may be represented based on time intervals. For example, the daily usage profiles may be represented using six-hour intervals corresponding to morning (6 AM to 12 PM), afternoon (12 PM to 6 PM), evening (6 PM to 12 AM), and night (12 AM to 6 AM).

Referring briefly to FIG. 4, an exemplary daily energy usage profile 400 is shown for a household 402, which may be a non-limiting example of a household 206 of FIG. 2. In the depicted embodiment, daily energy usage profile 400 is a graph of an amount of energy consumed by household 402 over time, as indicated by a plot 404. The amount of energy consumed by the household 402 is shown on a vertical axis of the graph, in kilowatts. Time is shown on a horizontal axis of the graph, expressed in hours, from 0 (e.g., midnight) to 24 (e.g., midnight the following day).

As indicated by plot 404, the amount of energy consumed by household 402 is low during the night, from midnight to around 5:00 AM. From 5:00 AM, the amount of energy consumed by household 402 increases until around 3:00 PM (e.g., 15 hours). From 3:00 PM to midnight, the amount of energy consumed by household 402 decreases, until reaching a consumption similar to midnight on the previous night. Thus, plot 404 shows that household 402 consumes the highest amount of energy during the day in the afternoon, between the hours of 12:00 PM, indicated by a dashed line 410, and 6:00 PM (e.g., 18 hours), indicated by a dashed line 412. Accordingly, based on daily energy usage profile 400, household 402 may be classified as an afternoon consumption household.

Household 402 may be compared with other households within a household energy monitoring ecosystem, such as household energy monitoring ecosystem 202 of FIG. 2. In other words, daily energy usage profile 400 may be compared with other daily energy usage profiles of other households, and households with similar energy usage patterns may be classified into a same representative behavioral reference group of households. For example, household 402 may be classified into a representative behavioral reference group including afternoon consumption households, while other households may be classified into evening consumption households, morning consumption households, etc.

FIG. 5 shows an exemplary energy usage profile matrix 500, which depicts a plurality of different daily energy usage patterns that may be seen in various daily energy usage profiles 400, where the daily energy usage patterns have been classified into six classifications corresponding to representative behavioral reference groups. A first column 501 shows a first representative behavioral reference group of afternoon energy consumers; a second column 502 shows a second representative behavioral reference group of evening energy consumers; a third column 503 shows a third representative behavioral reference group of afternoon and evening energy consumers; a fourth column 504 shows a fourth representative behavioral reference group of night energy consumers; a fifth column 505 shows a fifth representative behavioral reference group of morning energy consumers; and a sixth column 506 shows a sixth representative behavioral reference group of morning and afternoon energy consumers. It should be appreciated that the examples included herein are for illustrative purposes, and in other embodiments, different classifications and/or different numbers of representative behavioral reference groups may be used without departing from the scope of this disclosure.

Each representative behavioral reference group includes a plurality of households having a similar energy usage pattern. The plurality of households may be further divided into different subgroups based on housing characteristics. For example, a first row 510 may correspond to a house footprint HS1 of a first size; a second row 511 may correspond to a house footprint HS2 of a second size; a third row 512 may correspond to a house footprint HS3 of a third size; a fourth row 513 may correspond to a house footprint HS4 of a fourth size; and a fifth row 514 may correspond to a house footprint HS5 of a fifth size; where the first, second, third, fourth, and fifth sizes may be different. Thus, each energy usage pattern depicted in matrix 500 may be a pattern typical of households of a given size within a given representative behavioral reference group.

For example, a first energy usage pattern 520 corresponds to households of house footprint HS1 that are afternoon energy consumers, where each of the households of house footprint HS1 that are afternoon energy consumers may have a daily energy usage profile 400 similar to first energy usage pattern 520 (e.g., as determined by a clustering algorithm); a second energy usage pattern 521 corresponds to households of house footprint HS2 that are evening energy consumers, where each of the households of house footprint HS2 that are evening energy consumers may have a daily energy usage profile 400 similar to second energy usage pattern 520; and so on.

Returning to method 300, in some embodiments, load shapes may be extracted from the daily energy usage profiles. For normative messages to induce meaningful reductions in energy consumption, a nontrivial variation should exist in household consumption within the representative behavioral reference group. In other words, when there is little difference between the norm and high users, there is little possibility for reductions in energy use, as normative messaging campaigns attempt to get individuals to conform to social norms (e.g., to reduce from high used to norm use). Therefore, individual households may be classified in accordance with load shapes when the daily energy usage profiles vary in consumption. Various load shape extraction methods may be applied to generate the load shapes, such as a gradient method, where a rate of change in energy consumption may be calculated by subtracting original values of energy consumption between two consecutive time points; a normalization method, where normalized energy consumption is concluded by transforming an original value of energy consumption to a range of 0 to 1; and/or a related method, where a cumulative percentage of energy consumption is calculate by dividing the cumulative energy consumption at each time by a total amount of daily energy consumption.

Performing the clustering analysis may include applying one or more clustering algorithms to the daily energy usage profile data to generate a number of historical daily energy usage patterns. The one or more clustering algorithms may include, for example, a K-means clustering algorithm, a hierarchical clustering algorithm, or a different clustering algorithm. In some embodiments, the results of the one or more clustering algorithms may be evaluated using various clustering evaluation criteria known in the art, to determine a most suitable number of behavioral reference groups based on the historical daily energy usage patterns.

At 310, method 300 includes labeling the collected data using the identified groups, and storing the labeled data in an energy usage profile database (e.g., energy usage profile database 116 of FIG. 1 and/or daily energy usage profile database 226 of FIG. 2). The energy usage profile database may accumulate daily energy usage profile data over time, such that a current or recent daily energy usage profile may be compared to an increasing amount of historical data, for example, to determine trends in energy usage.

At 312, method 300 includes training one or more classification models to classify households to the behavioral reference groups. The one or more classification models may include, for example, hierarchical models (e.g., decision trees, etc.); statistical models (e.g., discriminant analysis, k-nearest neighbor, etc.); support vector machines; machine learning or deep learning models; or a different kind of classification model. Once the one or more classification models are trained, the households may be classified to the behavioral reference groups using one or more trained classification models.

At 314, method 300 includes generating personalized normative energy usage feedback messages for groups of similar households, based on the classifications established by the clustering algorithm(s) and/or trained classification models. In some embodiments, the feedback messages may include comparisons of an individual household's energy consumption over a predefined period (e.g., a billing cycle, a month, a week, etc.) with an average energy consumption of other households in a same representative behavioral reference group. Additionally or alternatively, injunctive norms (e.g., that express approval or disapproval) may be included in the feedback messages.

Comparison groups may be made by households that exhibit similar lifestyles classified by daily energy load shape, sharing similar housing characteristics (e.g., households of similar-size homes within 4 miles). Since households may have multiple lifestyle patterns during a billing cycle, a most representative lifestyle is selected as the reference lifestyle in the billing cycle. In some embodiments, descriptive feedback may then be generated by comparing a household's average energy consumption with the median energy consumption of the behavioral reference group. In other embodiments, a household's energy consumption during certain hours of the day may be compared to a median or average energy consumption of the behavioral reference group during the same hours of the day. Injunctive feedback is also generated by indicating how good they are in energy saving compared to the behavioral reference group.

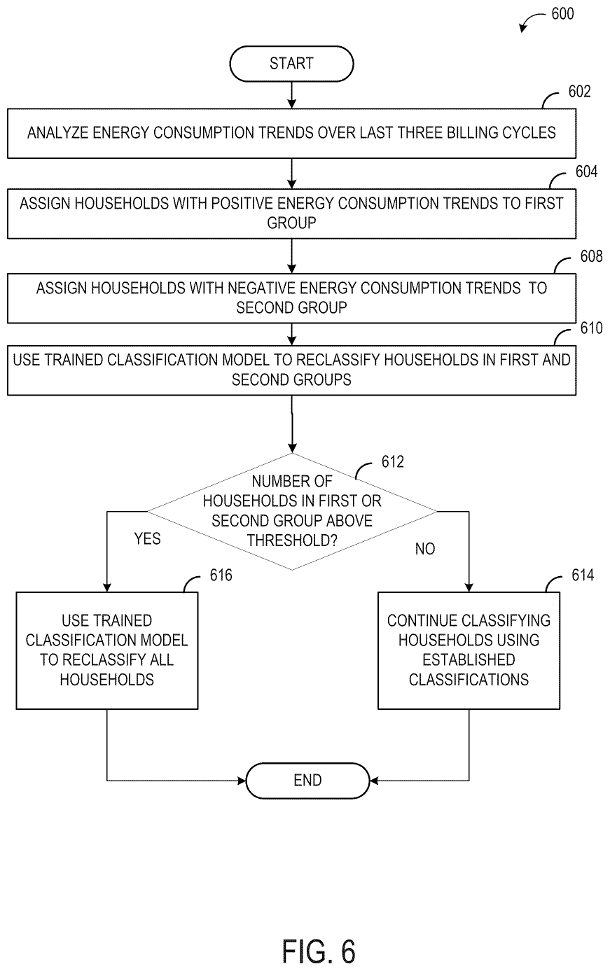

At 316, method 300 includes determining whether conditions have been met for reclassifying one or more households. Determining whether the conditions have been met for reclassifying one or more households is described below in reference to FIG. 6.

If at 316 it is determined that the conditions have been met for reclassifying the one or more households, method 300 proceeds to 318. At 318, method 300 includes using the one or more trained classification models to reclassify the one or more households, and method 300 proceeds back to 310. Alternatively, if at 316 it is determined that the conditions have not been met for reclassifying the one or more households, method 300 proceeds to 320.

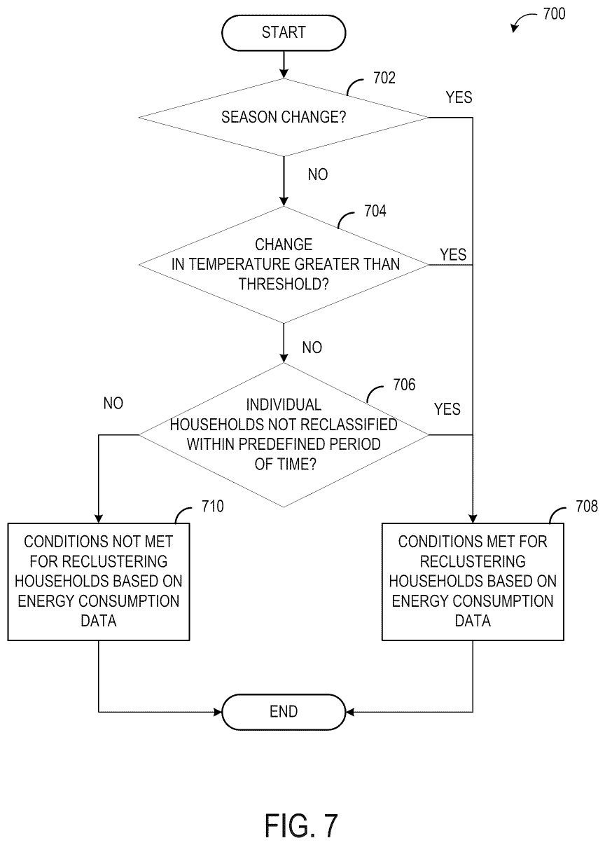

At 320, method 300 includes determining whether conditions have been met for reclustering the plurality of households. Determining whether the conditions have been met for reclustering the plurality of households is described below in reference to FIG. 7. Reclustering the plurality of households may include performing the clustering analysis described above at step 306, to identify a new set of representative behavioral reference groups into which the plurality of households may more accurately be classified, based on a similarity of an energy usage pattern of a representative behavioral reference group with the energy usage profiles of the households.

If at 320 it is determined that the conditions have been met for reclustering, method 300 proceeds to 322. At 322, method 300 includes reclustering the households based on the collected energy consumption data, and method 300 proceeds back to 306. Alternatively, if at 322 it is determined that the conditions have not been met for reclustering, method 300 proceeds to 324. At 324, method 300 includes continuing to classify the household using the trained classification models, and method 300 ends.

Turning now to FIG. 6, a method 600 is shown for determining whether conditions have been met for reclassifying one or more households of a household energy monitoring ecosystem, such as household energy monitoring ecosystem 202 of FIG. 2. Method 600 may be performed as part of method 300 described above in reference to FIG. 3. As explained above, the reclassification of households and/or reclustering can lead to a more precise identification of households for messaging, selection of types of messaging, etc. However, repeated reclassification and/or reclustering increases demands on memory usage and processing resources of the utility, particular when increased factors are used in therein in addition to the energy usage of a particular household. As such, there can be technical challenges in enabling sufficiently accurate messages with changing conditions.

One technical solution to these technical challenges is to trigger the reclassification and/or reclustering in a way that not only takes advantage of unexpected changes in conditions, but also that integrates those changes with their impact on household lifestyle at both the individual and group level. Further, to reduce the potential for stagnation, reclassification and/or reclustering may also be integrated into the approach at appropriate intervals to persistently excite the learning system without overly burdening processing demands. Specific details of these approach are explained with regard to FIGS. 6-7. It should be appreciated that such an approach does not simply use a computer processor to process data as a tool, but rather sets up a particular approach that achieves the desired processing result, with less processing resources than would otherwise be used if a more direct calculation was used.

At 602, the method analyzes energy consumption trends over last three billing cycles for each household. The number of billing cycles may also be adjusted based on the average change of energy consumption for a geographic region surrounding the household, where an increase in the average change reduces the number of billing cycles utilized, for example proportionally with a scaling factor.

At 604, the method then assigns households with positive energy consumption trends to a first group. A positive energy consumption trend may be defined as a trend towards consuming less energy. For example, energy consumption data of a first percent (e.g., 10%) of the households may indicate a significant reduction in household energy usage, and the first percent of the households may be assigned to the first group. The significant reduction may be defined as a reduction in energy usage by more than a first predefined threshold value. The first predefined threshold value may be determined based on various factors, such as variability in energy usage in a geographical region of the households, historical energy usage data, a success rate of historical normative messaging campaigns targeting the households, and/or other factors.

At 608, the method includes assigning households with negative energy consumption trends to a second group, where a negative energy consumption trend may be defined as a trend towards consuming more energy. For example, energy consumption data of a second percent (e.g., 15%) of the households may indicate an increase in household energy usage by more than a second predefined threshold value, and the second percent of the households may be assigned to the second group. The second predefined threshold value may be determined based on the same or similar factors as the first predefined threshold value.

At 610, the method applies a trained classification model to reclassify households in the first and second groups. The trained classification model may be a same classification model previously used to classify the households, or a different trained classification model. Reclassifying the households of the first and second groups may include examining each household of the first and second groups to determine, in light of their reduction or increase in energy use, respectively, whether a different behavioral reference group would more accurately represent the household than a previously assigned behavioral reference group (e.g., assigned during a previous classification or reclassification). As a result, a first portion of the households of each of the first and second groups may be reclassified (e.g., reassigned), and a second portion of the households of each of the first and second groups may not be reclassified, and may remain in their previously assigned behavioral reference group.

At 612, the number of households in the first and second groups are each compared to a maximum threshold. If above the threshold in either case, at 616, the trained classification model may be used to reclassify all of the households (e.g., not just the households in the first and second groups). Alternatively, if the number of households in both of the first and second groups is below the threshold, the previously established classifications are maintained at 614. In this way, based on the changing energy usage, reclassification is triggered and thus can provide accurate reclassification without over-burdening processing resources by classifying periodically or seasonally.

In other words, the households are divided into three categories: a first category of households that may be candidates for being reclassified to a behavioral reference group characterized by a lower amount of household energy use (e.g., the first group); a second category of households that may be candidates for being reclassified to a behavioral reference group characterized by a higher amount household energy use (e.g., the second group); and a third category of households whose energy consumption has not changed significantly. By first classifying positive versus negative usage trends prior to performing a reclassification, it is possible to save substantial processing resources by limiting the actors to those beyond the energy usage trend. That is, the reclassification is performed for the first and second categories, and the reclassification is not performed for the third category. As the third category may include more households than either of the first and second categories, significant processing resources may be saved by not performing the reclassification of households of the third category. However, if large numbers of households are either reducing or increasing their energy use (e.g., above either of the first or second thresholds, respectively), it may be inferred that the classifications of the third category of households may be inaccurate, whereby all of the households may be reclassified. Further, in some cases, if large numbers of households are either reducing or increasing their energy use, a reclustering may be performed to generate new behavioral reference groups, as described in greater detail below in reference to FIG. 7.

Additionally, different personalized normative feedback messages may be sent to the first, second, and third categories of households. For example, positive injunctive feedback regarding their energy consumption trends may be directed to the first category (e.g., the first group); negative injunctive feedback regarding their energy consumption trends may be directed to the second category (e.g., the second group); and the third category of households may receive neither positive nor negative injunctive feedback. For example, the third category of households may receive a different kind of personalized feedback, or no feedback.

Turning now to FIG. 7, a method 700 is shown for determining whether conditions have been met for reclustering the plurality of households of a household energy monitoring ecosystem, such as household energy monitoring ecosystem 202 of FIG. 2. Method 700 may be performed as part of method 300 described above in reference to FIG. 3.

As noted above, reclustering can drain processing resources, and while repeated reclustering can provide more accurate identification of household lifestyle, thus leading to more accurate grouping, the approach described herein has identified particular factors that correlate with relevant changes in lifestyle so as to provide beneficial reclustering when appropriate and with substantial increase in accurate identification.

At 702, 704, and 706, relevant parameters are evaluated to trigger reclustering. While this particular approach identifies three such determinations that are advantageously used together to synergistically increase model accuracy while avoiding overtaxing processing demands, other variations are possible and fewer and/or additional parameters may also be considered.

Specifically, at 702, method 700 includes determining whether a season change has been detected. For example, the season change may be a transition from spring to summer, a transition from fall to winter, etc. In various embodiments, the change in season may be detected based on various factors, including a time of the year, a current temperature, a presence of one or more climate conditions, and/or other data. In some examples, a climate model may be used. During such transitions, household energy usage patterns may change, whereby it may be beneficial to recluster the households. Thus, if a season change occurs, method 700 proceeds to 708, where conditions are determined to be met for reclustering the households based on energy consumption data. In response to the conditions being met, the households may be clustered, as described in reference to method 300 of FIG. 3. Alternatively, if a season change has not occurred, method 700 proceeds to 704.

At 704, method 700 includes determining whether a change in an environmental temperature has occurred, where the change exceeds a threshold temperature change. For example, during the fall, an unexpected period of prolonged cold weather may occur, which may last a week or more. Alternatively, a period of unseasonably warm weather may occur during the spring. In such cases, method 700 may proceed to 708, where conditions are determined to be met for reclustering the households. If a change in an environmental temperature has not occurred, method 700 proceeds to 706.

At 706, method 700 includes determining whether households have been reclassified (e.g., reassigned to a new behavioral reference group) within a pre-defined period of time corresponding to a maximum duration of a classification. For example, the maximum duration of a classification may be 12 months, where the classification may be considered valid for 12 months, and not valid if exceeding 12 months. In other words, if a substantial period of time has passed without a household reclassification (e.g., more than a year), for example, in accordance with method 300, then method 700 proceeds to 708, where the conditions are determined to be met for reclustering the households. If no households have been reclassified within the pre-defined period of time, then method 700 proceeds to 710, where the conditions for reclustering the households are not met.

Thus, the method identifies whether each of a season change or temperature change are present. Further, even if none of these conditions has occurred, the system further considers whether insufficient reclustering has occurred in a longer period than a season (e.g., a year), to force reclustering if one or more clusters has become stagnant, for example, or even if a particular household has been stagnantly clustered in the same cluster longer than a threshold duration (e.g., 2 years). In this way, the approach forces reclustering to be persistent, and reduces the potential for stagnant clustering of a particular household, leading to stagnation in messaging that may eventually become ignored by the household even if the lifestyle is accurately tracked.

The technical effect of dynamically reclassifying households into behavioral reference groups and/or dynamically reclustering households into new behavioral reference groups is that customized normative messaging campaigns directed at the behavioral reference groups may be more effective at convincing the households to lower their energy usage.

The disclosure also provides support for a method for an energy reduction messaging system, the method comprising: collecting a first set of energy consumption data from a plurality of households at a first time, performing a first clustering analysis of the first set of energy consumption data to identify a first plurality of behavioral reference groups of households that share similar behavioral patterns with respect to household energy usage, training a first classification model to classify each household of the plurality of households to a behavioral reference group of the first plurality of behavioral reference groups, based on the first set of energy consumption data, collecting a second set of energy consumption data from the plurality of households at a second time, the second time after the first time, and in response to a first set of conditions being met, automatically reclassifying one or more households of the plurality of households into the first plurality of behavioral reference groups using the trained first classification model. In a first example of the method, the method further comprises: generating a personalized normative energy usage feedback message for each behavioral reference group of the first plurality of behavioral reference groups, and sending the personalized normative energy usage feedback message to each household included in each behavioral reference group. In a second example of the method, optionally including the first example, the personalized normative energy usage feedback message includes injunctive normative feedback indicating a level of social approval or disapproval of the behavioral patterns with respect to household energy usage of the households of a relevant behavioral reference group of the first plurality of behavioral reference groups. In a third example of the method, optionally including one or both of the first and second examples, the energy consumption data includes a daily energy usage profile of a household of the plurality of households. In a fourth example of the method, optionally including one or more or each of the first through third examples, automatically reclassifying the one or more households of the plurality of households into different behavioral reference groups in response to the first set of conditions being met further comprises: assigning one or more households with a first energy consumption trend towards decreased energy use to a first group of households, assigning one or more households with a second energy consumption trend towards increased energy use to a second group of households, reclassifying the first group of households and the second group of households to the first plurality of behavioral reference groups, using the first trained classification model, and not reclassifying households that are not in either of the first group or the second group. In a fifth example of the method, optionally including one or more or each of the first through fourth examples, a behavioral reference group to which a household is reclassified is different from a previous behavioral reference group of the household. In a sixth example of the method, optionally including one or more or each of the first through fifth examples, the method further comprises: in response to a number of households in the first group or the second group exceeding a threshold number of households, reclassifying all of the one or more households into the first plurality of behavioral reference groups. In a seventh example of the method, optionally including one or more or each of the first through sixth examples, the method further comprises: in response to a second set of conditions being met: automatically performing a second clustering analysis of the second set of energy consumption data to identify a second plurality of behavioral reference groups of households that share similar behavioral patterns with respect to household energy usage, training a second classification model to classify each household of the plurality of households to a behavioral reference group of the second plurality of behavioral reference groups, based on the second set of energy consumption data, and reclassifying the plurality of households into the second plurality of behavioral reference groups using the trained second classification model. In a eighth example of the method, optionally including one or more or each of the first through seventh examples, the second plurality of behavioral reference groups of households is different from the first plurality of behavioral reference groups of households. In a ninth example of the method, optionally including one or more or each of the first through eighth examples, the second classification model is the same as the first classification model, and the first classification model is retrained on the second set of energy consumption data. In a tenth example of the method, optionally including one or more or each of the first through ninth examples, automatically performing the second clustering analysis of the second set of energy consumption data in response to the second set of conditions being met further comprises automatically performing the second clustering analysis in response to any of a season change occurring, a change in temperature occurring that is greater than a threshold temperature, and one or more households of the plurality of households not being reclassified within a pre-defined period of time.

The disclosure also provides support for an energy reduction messaging system, comprising: smart metering technology installed at a plurality of households that measure energy consumption data of the plurality of households in real-time or at predetermined intervals, a processor, and a non-transitory memory storing instructions that when executed, cause the processor to: collect a first set of energy consumption data from a plurality of households at a first time, using the smart metering technology, perform a first clustering analysis of the first set of energy consumption data to cluster the plurality of households into a first plurality of behavioral reference groups, train a classification model to classify each household of the plurality of households to a behavioral reference group of the first plurality of behavioral reference groups, collect a second set of energy consumption data from the plurality of households at a second time, the second time after the first time, automatically reclassify one or more households of the plurality of households having a first energy consumption trend towards decreased energy use into the first plurality of behavioral reference groups, using the trained classification model, automatically reclassify one or more households of the plurality of households having a second energy consumption trend towards increased energy use into the first plurality of behavioral reference groups using the trained classification model, and not reclassify households of the plurality of households not having either of the first energy consumption trend or the second energy consumption trend. In a first example of the system, further instructions are stored in the non-transitory memory that when executed, cause the processor to reclassify all of the plurality of households in response to a number of households of having either of the first energy consumption trend or the second energy consumption trend being greater than a threshold number. In a second example of the system, optionally including the first example, further instructions are stored in the non-transitory memory that when executed, cause the processor to generate a personalized normative energy usage feedback message for each behavioral reference group of the first plurality of behavioral reference groups, and send the personalized normative energy usage feedback message to each household included in each behavioral reference group. In a third example of the system, optionally including one or both of the first and second examples, the first clustering analysis is performed on daily energy usage profiles of the plurality of households, the daily energy usage profiles generated from the first set of energy consumption data. In a fourth example of the system, optionally including one or more or each of the first through third examples, further instructions are stored in the non-transitory memory that when executed, cause the processor to: in response to one or more of a season change occurring, a change in temperature occurring that is greater than a threshold temperature, and one or more households of the plurality of households not being reclassified within a pre-defined period of time: perform a second clustering analysis of the second set of energy consumption data to identify a second, different plurality of behavioral reference groups of households, retrain the classification model to classify each household of the plurality of households to a behavioral reference group of the second plurality of behavioral reference groups, based on the second set of energy consumption data, and reclassify the plurality of households into the second plurality of behavioral reference groups using the retrained classification model. In a fifth example of the system, optionally including one or more or each of the first through fourth examples, the second plurality of behavioral reference groups of households is different from the first plurality of behavioral reference groups of households.

The disclosure also provides support for a method for a computer for sending personalized normative energy usage feedback messages to households, the method comprising: collecting household energy consumption data from a plurality of households using smart energy metering technology, analyzing the collected household energy consumption data to identify a set of reference groups of households that share similar behavioral patterns with respect to household energy usage, assigning each household of the plurality of households to a reference group of the set of reference groups, sending normative energy usage feedback messages that are personalized for each reference group to the plurality of households, in response to a change in a daily energy usage profile of a household above a threshold, reassigning the household to a different reference group, and in response to one or more of a season change occurring, a change in temperature above a threshold occurring, and one or more households of the plurality of households not being reassigned within a pre-defined period of time, reanalyzing the collected household energy consumption data to identify a new set of reference groups. In a first example of the method, analyzing the collected household energy consumption data to identify the set of reference groups further comprises: generating daily energy usage profiles for each household of the plurality of households from the collected household energy consumption data, performing a clustering analysis on the daily energy usage profiles to identify the set of reference groups. In a second example of the method, optionally including the first example, the method further comprises: training a classification model to assign each household of the plurality of households to a reference group of the set of reference groups, and in response to the change in the daily energy usage profile of the household above the threshold, using the trained classification model to reassign the household to a different reference group.

When introducing elements of various embodiments of the present disclosure, the articles “a,” “an,” and “the” are intended to mean that there are one or more of the elements. The terms “first,” “second,” and the like, do not denote any order, quantity, or importance, but rather are used to distinguish one element from another. The terms “comprising,” “including,” and “having” are intended to be inclusive and mean that there may be additional elements other than the listed elements. As the terms “connected to,” “coupled to,” etc. are used herein, one object (e.g., a material, element, structure, member, etc.) can be connected to or coupled to another object regardless of whether the one object is directly connected or coupled to the other object or whether there are one or more intervening objects between the one object and the other object. In addition, it should be understood that references to “one embodiment” or “an embodiment” of the present disclosure are not intended to be interpreted as excluding the existence of additional embodiments that also incorporate the recited features.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, the examples and embodiments, in all respects, are meant to be illustrative only and should not be construed to be limiting in any manner.

1. A method for an energy reduction messaging system, the method comprising:
collecting a first set of energy consumption data from a plurality of households at a first time;
performing a first clustering analysis of the first set of energy consumption data to identify a first plurality of behavioral reference groups of households that share similar behavioral patterns with respect to household energy usage;
training a first classification model to classify each household of the plurality of households to a behavioral reference group of the first plurality of behavioral reference groups, based on the first set of energy consumption data;
collecting a second set of energy consumption data from the plurality of households at a second time, the second time after the first time; and
in response to a first set of conditions being met, automatically reclassifying one or more households of the plurality of households into the first plurality of behavioral reference groups using the trained first classification model.

2. The method of claim 1, further comprising:
generating a personalized normative energy usage feedback message for each behavioral reference group of the first plurality of behavioral reference groups; and
sending the personalized normative energy usage feedback message to each household included in each behavioral reference group.

3. The method of claim 2, wherein the personalized normative energy usage feedback message includes injunctive normative feedback indicating a level of social approval or disapproval of the behavioral patterns with respect to household energy usage of the households of a relevant behavioral reference group of the first plurality of behavioral reference groups.

4. The method of claim 1 wherein the energy consumption data includes a daily energy usage profile of a household of the plurality of households.

5. The method of claim 1, wherein automatically reclassifying the one or more households of the plurality of households into different behavioral reference groups in response to the first set of conditions being met further comprises:
assigning one or more households with a first energy consumption trend towards decreased energy use to a first group of households;
assigning one or more households with a second energy consumption trend towards increased energy use to a second group of households;
reclassifying the first group of households and the second group of households to the first plurality of behavioral reference groups, using the first trained classification model; and
not reclassifying households that are not in either of the first group or the second group.

6. The method of claim 5, wherein a behavioral reference group to which a household is reclassified is different from a previous behavioral reference group of the household.

7. The method of claim 5, further comprising, in response to a number of households in the first group or the second group exceeding a threshold number of households, reclassifying all of the one or more households into the first plurality of behavioral reference groups.

8. The method of claim 1, further comprising, in response to a second set of conditions being met:
automatically performing a second clustering analysis of the second set of energy consumption data to identify a second plurality of behavioral reference groups of households that share similar behavioral patterns with respect to household energy usage;
training a second classification model to classify each household of the plurality of households to a behavioral reference group of the second plurality of behavioral reference groups, based on the second set of energy consumption data; and
reclassifying the plurality of households into the second plurality of behavioral reference groups using the trained second classification model.

9. The method of claim 8, wherein the second plurality of behavioral reference groups of households is different from the first plurality of behavioral reference groups of households.

10. The method of claim 8, wherein the second classification model is the same as the first classification model, and the first classification model is retrained on the second set of energy consumption data.

11. The method of claim 8, wherein automatically performing the second clustering analysis of the second set of energy consumption data in response to the second set of conditions being met further comprises automatically performing the second clustering analysis in response to any of a season change occurring, a change in temperature occurring that is greater than a threshold temperature, and one or more households of the plurality of households not being reclassified within a pre-defined period of time.

12. An energy reduction messaging system, comprising:
smart metering technology installed at a plurality of households that measure energy consumption data of the plurality of households in real-time or at predetermined intervals;
a processor, and a non-transitory memory storing instructions that when executed, cause the processor to:
collect a first set of energy consumption data from a plurality of households at a first time, using the smart metering technology;
perform a first clustering analysis of the first set of energy consumption data to cluster the plurality of households into a first plurality of behavioral reference groups;
train a classification model to classify each household of the plurality of households to a behavioral reference group of the first plurality of behavioral reference groups;
collect a second set of energy consumption data from the plurality of households at a second time, the second time after the first time;
automatically reclassify one or more households of the plurality of households having a first energy consumption trend towards decreased energy use into the first plurality of behavioral reference groups, using the trained classification model;
automatically reclassify one or more households of the plurality of households having a second energy consumption trend towards increased energy use into the first plurality of behavioral reference groups using the trained classification model; and
not reclassify households of the plurality of households not having either of the first energy consumption trend or the second energy consumption trend.

13. The energy reduction messaging system of claim 12, wherein further instructions are stored in the non-transitory memory that when executed, cause the processor to reclassify all of the plurality of households in response to a number of households of having either of the first energy consumption trend or the second energy consumption trend being greater than a threshold number.

14. The energy reduction messaging system of claim 12, wherein further instructions are stored in the non-transitory memory that when executed, cause the processor to generate a personalized normative energy usage feedback message for each behavioral reference group of the first plurality of behavioral reference groups; and send the personalized normative energy usage feedback message to each household included in each behavioral reference group.

15. The energy reduction messaging system of claim 12, wherein the first clustering analysis is performed on daily energy usage profiles of the plurality of households, the daily energy usage profiles generated from the first set of energy consumption data.

16. The energy reduction messaging system of claim 12, wherein further instructions are stored in the non-transitory memory that when executed, cause the processor to:
in response to one or more of a season change occurring, a change in temperature occurring that is greater than a threshold temperature, and one or more households of the plurality of households not being reclassified within a pre-defined period of time:
perform a second clustering analysis of the second set of energy consumption data to identify a second, different plurality of behavioral reference groups of households;
retrain the classification model to classify each household of the plurality of households to a behavioral reference group of the second plurality of behavioral reference groups, based on the second set of energy consumption data; and
reclassify the plurality of households into the second plurality of behavioral reference groups using the retrained classification model.

17. The energy reduction messaging system of claim 16, wherein the second plurality of behavioral reference groups of households is different from the first plurality of behavioral reference groups of households.

18. A method for a computer for sending personalized normative energy usage feedback messages to households, the method comprising:
collecting household energy consumption data from a plurality of households using smart energy metering technology;
analyzing the collected household energy consumption data to identify a set of reference groups of households that share similar behavioral patterns with respect to household energy usage;
assigning each household of the plurality of households to a reference group of the set of reference groups;
sending normative energy usage feedback messages that are personalized for each reference group to the plurality of households;
in response to a change in a daily energy usage profile of a household above a threshold, reassigning the household to a different reference group; and
in response to one or more of a season change occurring, a change in temperature above a threshold occurring, and one or more households of the plurality of households not being reassigned within a pre-defined period of time, reanalyzing the collected household energy consumption data to identify a new set of reference groups.

19. The method of claim 18, wherein analyzing the collected household energy consumption data to identify the set of reference groups further comprises:
generating daily energy usage profiles for each household of the plurality of households from the collected household energy consumption data;
performing a clustering analysis on the daily energy usage profiles to identify the set of reference groups.

20. The method of claim 18, further comprising training a classification model to assign each household of the plurality of households to a reference group of the set of reference groups, and in response to the change in the daily energy usage profile of the household above the threshold, using the trained classification model to reassign the household to a different reference group.
